(19) United States
(12) Patent Application Publication
(10) Pub. No.: US 2025/0021821 A1
(43) Pub. Date: Jan. 16, 2025

(54) METHOD FOR CALCULATING FEASIBLE PROCESS PARAMETERS

(71) Applicant: METATECH (AP) INC., New Taipei City (TW)

(72) Inventors: YING-CHEN YANG, Taipei City (TW); TZU-LUNG SUN, New Taipei City (TW); YEONG-SUNG LIN, Taipei (TW); TSUNG-CHI CHEN, New Taipei City (TW)

(21) Appl. No.: 18/764,919

(22) Filed: Jul. 5, 2024

Related U.S. Application Data
(60) Provisional application No. 63/525,786, filed on Jul. 10, 2023.

(51) Int. Cl. G06N 3/0895

(52) U.S. Cl. CPC G06N 3/0895

(57) ABSTRACT

A method for calculating feasible process parameters of the present invention constructs an optimization model by treating a trained predictive model as a function of process parameters to be determined, wherein the objective function is to minimize the difference between the function value and the target result, subject to the conditions that the process parameters to be determined must satisfy, either individually or in relation to each other. Moreover, in order to solve the constrained optimization problem, the method with penalty function and barrier function can be used to convert the constrained optimization problem into an unconstrained optimization problem to make it more convenient to solve. For this optimization problem, the dataset of the trained predictive model can be used to find multiple samples that meet the target results as anchor points to form a multi-dimensional feasible solution space, and set or make initial solutions in this feasible solution space, and then use different numerical analysis methods to find the direction and step size to further find the optimal feasible solution, and this optimal feasible solution is the input parameter that can be used.

### BACKGROUND OF THE INVENTION

### 1. Field of the Invention

The present invention relates to a method for calculating process parameters, and more particularly, to a method of applying optimization technique-based algorithms and trained predictive models to deduce the unconfirmed process parameters inversely.

### 2. Description of the Prior Art

With the advances in biomedical engineering technology, the applications of regenerative medicine in the treatment of clinical diseases have increased. Regenerative medicine is a medical technique with wide application fields that focuses on the ability of cells to regenerate and repair damaged tissues and organs. It can also be used in combination with other medical techniques, such as tissue engineering and molecular biology, to improve and treat previously untreatable diseases such as diabetes, neurological diseases, cardiovascular diseases, and cancer. Currently, regenerative medicine is mainly applied to organ repair, immune cell therapy, and stem cell therapy. There is a growing interest in the research and application of cell therapy in regenerative medicine. Cell therapy is the process of culturing or processing cells from a human body in vitro and then transplanting the cells to the human body to replace or repair damaged tissue and/or cells.

In recent years, governments in many countries have gradually opened up the use of cell therapy, and more and more academics, both domestic and foreign, have become involved in cell therapy research, resulting in significant advances in the treatment of a wide range of diseases. For instance, autologous fibroblasts are used for treating skin defects, autologous chondrocytes for treating cartilage defects in the knee, and autologous bone marrow mesenchymal stem cells for treating spinal cord injuries. Because the quality of cell therapy products directly impacts their safety and efficacy, it is crucial to strictly control the growth conditions of cells during the cell culture process and to monitor the culture parameters and environmental parameters in real time to prevent contamination or poor quality during cultivation. Furthermore, previous research has shown a high variability among cells in different cases, the optimal culture parameters and environmental parameters of cell preparations are not exactly the same in different cases. Consequently, each of the cell preparations in the process must adjust its process parameters to achieve the expected results, and it is not possible to produce each of the cell preparations with fixed process parameters. Additionally, due to the complexity and correlation of the processes, conventional techniques usually optimize only a single parameter, neglecting the combined interactive effects among various parameters throughout the entire process.

Conventional technology uses machine learning to train predictive models on large datasets of samples, and the predictive models can input various process parameters and generate predictive results for cell culture so that users can simulate the effect of their designed cell culture process in advance. However, the predictive models trained through machine learning are unable to deduce the process parameters in the cell culture process from the user's expected results. In other words, the users still need to try different process parameters when designing the cell culture process, which results in the design and improvement of the cell culture process consuming a lot of labor and resources. Besides the cell processes, other fields that employ machine learning-derived predictive models also face the issue of being unable to deduce the input parameters inversely.

Generally, a predictive model obtained through machine learning can be represented by a function (ƒ(x)). The method of deducing appropriate input parameters based on the expected results of the predictive model can be regarded as an optimization algorithm of the function. The optimization algorithm often involves using the derivatives of the function, i.e., differentiation of the function. However, the objective functions of predictive models trained by machine learning are typically non-symbolic, often non-differentiable, and sometimes even discontinuous. Consequently, it is challenging to compute the derivatives of the functions using numerical analysis methods. In other words, it is not easy to directly deduce input parameters using the objective function of the predictive model.

Therefore, developing a more comprehensive and accurate method that can inversely deduce process parameters to meet the expected results is necessary. This method should enable the determination and optimization of a plurality of parameters in the process.

### SUMMARY OF THE INVENTION

In view of this, one scope of the present invention is to provide a method for calculating feasible process parameters to solve the aforementioned problems. The method for calculating feasible process parameters is for identifying and optimizing a plurality of process parameters in a process. The plurality of process parameters comprises a plurality of confirmed input parameters and a plurality of unconfirmed input parameters. The method for calculating feasible process parameters comprises the following steps of: providing a trained predictive model, the trained predictive model being obtained by machine learning through a machine learning method on a dataset comprising a plurality of samples, each of the samples comprising a plurality of sample parameters, the trained predictive model being configured to input a plurality of input parameters and produce a predictive result corresponding to the input parameters; setting the predictive result of the trained predictive model as a target result and providing the confirmed input parameters in the input parameters; comparing whether the predictive result generated by each of the samples in the dataset input to the trained predictive model matches the target result, and selecting the samples with the predictive result matching the target result as a plurality of anchor samples to form a multi-dimensional subspace, and determining an initial sample in the multi-dimensional subspace; obtaining a direction for the initial sample in the multi-dimensional subspace; increasing the sample parameters of the initial sample by a step size along the direction and inputting the confirmed input parameters and the sample parameters, which do not correspond to the confirmed input parameters and are increased by the step size, into the trained predictive model to verify whether the generated predictive result matches the target result; and if the predictive result matches the target result, using the sample parameters, which do not correspond to the confirmed input parameters and are increased by the step size, as the unconfirmed input parameters.

Wherein, the step of determining the initial sample in the multi-dimensional subspace further comprises the following step: using a distance midpoint between at least two anchor samples in the multi-dimensional subspace as the initial sample.

Wherein, the step of determining the initial sample in the multi-dimensional subspace further comprises the following step: using a linear combination of at least two of the anchor samples in the multi-dimensional subspace as the initial sample.

Wherein, the step of obtaining the direction for the initial sample in the multi-dimensional subspace further comprises the following step: using the numerical analysis method to calculate a second directional derivative of the initial sample along each of the anchor samples, and as the direction for the initial sample.

Wherein, the step of obtaining the direction for the initial sample in the multi-dimensional subspace further comprises the following step: setting the initial sample as an origin, using the numerical analysis method to calculate a third directional derivative of the origin toward each of the anchor samples, and as the direction for the initial sample.

Wherein, the trained predictive model is represented by an objective function and the step of obtaining the direction for the initial sample in the multi-dimensional subspace further comprises the following step: using the numerical analysis method to calculate a function change value of the objective function based on a distance change value of the initial sample toward each of the anchor samples to obtain a cutline directional derivative of the initial sample toward each of the anchor samples.

Wherein, the step of obtaining the direction for the initial sample in the multi-dimensional subspace further comprises the following steps: sequentially increasing and adjusting the step size of the initial sample toward a directional derivative of each of the anchor samples; sequentially confirming whether a function value of the objective function is closer to the target result after increasing and adjusting the step size of the initial sample toward the directional derivative of each of the anchor samples; if confirming that the function value of the objective function is closer to the target result after increasing the step size of the initial sample toward the directional derivative of one of the anchor samples, then increasing the step size of the initial sample in the direction; and if confirmed that the function value of the objective function is not closer to the target result after increasing the step size of the initial sample toward the directional derivative of one of the anchor samples, then confirming whether the function value of the objective function is closer to the target result after increasing the step size of the initial sample toward the directional derivative of another one of the anchor samples.

Wherein, the step of increasing the sample parameters of the initial sample by the step size along the direction further comprises the following steps: setting an initial size of the step size, inputting the sample parameters of the initial sample in that direction by increasing the step size with the initial size, into the trained predictive model to verify whether the prediction result output by the trained predictive model is close to the target result; if the prediction result output by the trained predictive model is close to the target result, determining the step size to be the initial size; and if the prediction result output by the trained predictive model is not close to the target result, continuously adjusting a size of the step size, inputting the sample parameters of the initial sample in that direction by increasing the step size with the size, into the trained predictive model until the prediction result is close to the target result, and determining the step size to be the size.

Wherein, the trained predictive model comprises a function of process parameters to be determined, an objective function, and at least one constraint, the objective function minimizes a difference between an output value of the function of the process parameters to be determined and the target result, a constrained optimization problem is modeled based on the function of the process parameters to be determined, the objective function, the at least one constraint and the predictive result, the method for calculating feasible process parameter solves the constrained optimization problem to obtain the unconfirmed input parameters.

Wherein, the method for calculating feasible process parameters further comprises the following step: adding a barrier function to the objective function to constrain the process parameters to meet an inequality condition.

Wherein, the method for calculating feasible process parameters further comprises the following step: adding a penalty function to the objective function to constrain the process parameters to meet an equality condition.

Wherein, the dataset further comprises a process dataset, the process dataset comprises a plurality of process samples, and the sample parameters of each of the process samples comprise a source parameter and a culture parameter.

Wherein, the source parameter of each of the process samples further comprises an attribute data of a source of each of the process samples, and the culture parameter of each of the process samples further comprises operation, tool, material, method and environment data for each of the process samples.

Wherein, the trained predictive model is obtained through machine learning of the dataset with one of the following techniques: an Artificial Neural Network (ANN), a Convolutional Neural Network (CNN), and a Recurrent Neural Network (RNN).

Wherein, the method for calculating feasible process parameters further comprises the following steps: if the predictive result does not match the target result, re-comparing the confirmed input parameters and the sample parameters of the samples to select a second sample from the samples; calculating a gradient of the second sample in the target function of the trained predictive model with the numerical analysis method; increasing the sample parameters of the second sample by the step size along the opposite direction of the gradient and inputting all the sample parameters after increasing the step size into the trained predictive model to confirm whether the generated predictive result matches the target result; and if the predictive result matches the target result, using the sample parameters, which do not correspond to the confirmed input parameters and are increased by the step size, as the unconfirmed input parameters.

Another scope of the present invention is to provide a method for calculating feasible process parameters for identifying and optimizing a plurality of process parameters in a process. The plurality of process parameters comprises a plurality of confirmed input parameters and a plurality of unconfirmed input parameters. The method for calculating feasible process parameters comprises the following steps of: providing a plurality of trained predictive models, the trained predictive models being obtained by machine learning through a machine learning method on a dataset comprising a plurality of samples, each of the samples comprising a plurality of sample parameters, the trained predictive models being correspond to a plurality of objective functions and being configured to input a plurality of input parameters and produce a plurality of predictive results corresponding to the input parameters; the predictive results being belong to different target result types; combining the objective functions of the trained predictive models to form a combined objective function, wherein the combined objective function inputs the input parameters to generate the predictive results; setting the predictive results of the trained predictive models as a plurality of target result and providing the confirmed input parameters in the input parameters; comparing whether the predictive results generated by each of the samples in the dataset input to the trained predictive models respectively match the target results, and selecting the samples with the predictive results matching the target results as a plurality of anchor samples to form a multi-dimensional subspace, and determining an initial sample in the multi-dimensional subspace; obtaining a direction for the initial sample in the multi-dimensional subspace; increasing the sample parameters of the initial sample by a step size along the direction and inputting the confirmed input parameters and the sample parameters, which do not correspond to the confirmed input parameters and are increased by the step size, into the combined objective function to verify whether the generated predictive results match the target results; and if the predictive results match the target results, using the sample parameters, which do not correspond to the confirmed input parameters and are increased by the step size, as the unconfirmed input parameters.

Wherein, the method for calculating feasible process parameters further comprises the following step: adding a barrier function to the combined objective function to constrain the process parameters to meet an inequality condition.

Wherein, the method for calculating feasible process parameters further comprises the following step: adding a penalty function to the combined objective function to constrain the process parameters to meet an inequality condition.

In summary, the method for calculating feasible process parameters of the present invention constructs an optimization model by treating a trained predictive model as a function of process parameters to be determined, wherein the objective function is to minimize the difference between the function value and the target result, subject to the conditions that the process parameters to be determined must satisfy, either individually or in relation to each other. Moreover, in order to solve the constrained optimization problem, the method with penalty function and barrier function can be used to convert the constrained optimization problem into an unconstrained optimization problem to make it more convenient to solve. For this optimization problem, the dataset of the trained predictive model can be used to find multiple samples that meet the target results as anchor points to form a multi-dimensional feasible solution space, and set or make initial solutions in this feasible solution space, and then use different numerical analysis methods to find the direction and step size to further find the optimal feasible solution, and this optimal feasible solution is the input parameter that can be used. In addition, the method for calculating feasible process parameters of the present invention can be applied not only in the field of cell process, but also in any other trained machine learning models to invert their process parameters and unconfirmed input parameters.

### BRIEF DESCRIPTION OF THE APPENDED DRAWINGS

FIG. 1 is a flowchart diagram illustrating a method for calculating feasible process parameters according to an embodiment of the present invention.

FIG. 2 is a further flowchart diagram of the method for calculating feasible process parameters according to several embodiments of the present invention.

FIG. 3 is another further flowchart diagram of the method for calculating feasible process parameters according to several embodiments of the present invention.

FIG. 4 is a flowchart diagram illustrating for determining a direction in the method for calculating feasible process parameters according to several embodiments of the present invention.

FIG. 5 is a flowchart diagram illustrating for determining the direction in the method for calculating feasible process parameters according to several embodiments of the present invention.

FIG. 6 is a flowchart diagram illustrating for determining the direction in the method for calculating feasible process parameters according to another embodiment of the present invention.

FIG. 7 is a flowchart diagram illustrating for determining the direction in the method for calculating feasible process parameters according to another embodiment of the present invention.

FIG. 8 is a flowchart diagram illustrating a method for calculating feasible process parameters according to another embodiment of the present invention.

FIG. 9 is a flowchart diagram illustrating a method for calculating feasible process parameters according to another embodiment of the present invention.

FIG. 10 is a flowchart diagram illustrating a method for calculating feasible process parameters according to another embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments. Moreover, the devices in the figures are only used to express their corresponding positions and are not drawing according to their actual proportion.

In the description of this specification, the description with reference to the terms “an embodiment”, “another embodiment” or “part of an embodiment” means that a particular feature, structure, material or characteristic described in connection with the embodiment including in at least one embodiment of the present invention. In this specification, the schematic representations of the above terms do not necessarily refer to the same embodiment. Furthermore, the particular features, structures, materials or characteristics described may be combined in any suitable manner in one or more embodiments. Furthermore, the indefinite articles “a” and “an” preceding a device or element of the present invention are not limiting on the quantitative requirement (the number of occurrences) of the device or element. Thus, “a” should be read to include one or at least one, and a device or element in the singular also includes the plural unless the number clearly refers to the singular.

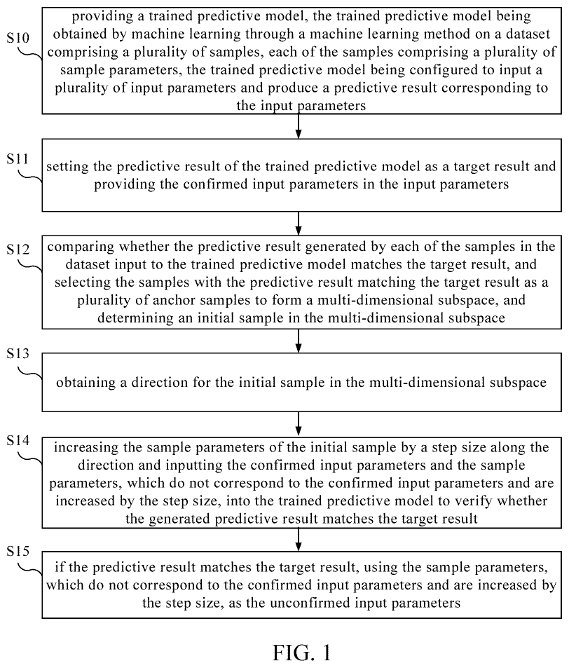

Please refer to FIG. 1. FIG. 1 is a flowchart diagram illustrating a method for calculating feasible process parameters according to an embodiment of the present invention. The method for calculating feasible process parameters is configured to identify and optimize a plurality of process parameters in a process. Wherein, the process parameters comprise a plurality of confirmed input parameters and a plurality of unconfirmed input parameters. The confirmed input parameters have been confirmed or executed by the user during operation, while unconfirmed input parameters have not yet been confirmed or executed by the user. The method for calculating feasible process parameters comprises the following steps: step S10: providing a trained predictive model, the trained predictive model being obtained by machine learning through a machine learning method on a dataset comprising a plurality of samples, each of the samples comprising a plurality of sample parameters, the trained predictive model being configured to input a plurality of input parameters and produce a predictive result corresponding to the input parameters; step S11: setting the predictive result of the trained predictive model as a target result and providing the confirmed input parameters in the input parameters; step S12: comparing whether the predictive result generated by each of the samples in the dataset input to the trained predictive model matches the target result, and selecting the samples with the predictive result matching the target result as a plurality of anchor samples to form a multi-dimensional subspace, and determining an initial sample in the multi-dimensional subspace; step S13: obtaining a direction for the initial sample in the multi-dimensional subspace; step S14: increasing the sample parameters of the initial sample by a step size along the direction and inputting the confirmed input parameters and the sample parameters, which do not correspond to the confirmed input parameters and are increased by the step size, into the trained predictive model to verify whether the generated predictive result matches the target result; and step S15: if the predictive result matches the target result, using the sample parameters, which do not correspond to the confirmed input parameters and are increased by the step size, as the unconfirmed input parameters.

In step S10 of this embodiment, the trained predictive models can be any models obtained from publicly available platforms that have undergone machine learning training or models that the users have trained through machine learning. Additionally, the dataset in this embodiment can be any data collection used for machine learning training, testing, and validation. In practice, the method for calculating feasible process parameters of the present embodiment can be applied to any other trained machine learning models to infer their unconfirmed input parameters. Furthermore, the trained predictive models in the present embodiment can be obtained through machine learning of the dataset with an Artificial Neural Network (ANN), a Convolutional Neural Network (CNN), a Recurrent Neural Network (RNN), or any other machine learning algorithms or neural network algorithms. Machine learning or neural network algorithms are based on the user's needs.

In practice, cell culture processes can involve numerous input parameters, some of which have already been confirmed or executed. The system and method of the present invention can be used to infer the parameters that have not yet been executed, ensuring that their execution will achieve the expected target results. For example, if a user intends to carry out a 21-day cell culture process with the expectation that the resulting cell preparation will have 95% cell viability, and the user has already completed 7 days of the process (i.e., confirmed input parameters). However, from day 8 to day 21, the process has not yet been determined or adjusted (i.e., unconfirmed input parameters) to achieve the desired target result on the preset day 21. Therefore, step S11 involves setting the conditions for inferring the input parameters.

In step S12, within the dataset used to train the predictive models, several specific samples will meet the user's set target results (for example, the aforementioned cell preparation with 95% cell viability). The samples are valuable for inferring the input parameters and can serve as anchor samples to form a multi-dimensional subspace. Points within this multi-dimensional subspace (representing vectors of the input parameters) input to the objective function of the trained predictive models will yield function values that meet the target results. Therefore, this multi-dimensional subspace can serve as a feasible solution space for the function of the trained predictive models. However, the function values of the points within the feasible solution space merely meet the target results and are not necessarily the optimal function values. Hence, in step S12, it is necessary to determine a point within the feasible solution space to serve as the initial point for finding a feasible solution, that is, to determine an initial sample.

After determining the initial sample, it is necessary to proceed from it in at least one direction and with at least one step size towards a feasible solution, as described in steps S13 and S14. After determining the direction at step S13, at least one step size is taken in this direction. The sample parameters, increased by the step size and not corresponding to the confirmed input parameters, are then input into the trained predictive model to verify whether the output function values meet the target results, as described in step S14. It should be noted that the input parameters for the trained predictive model include the confirmed input parameters and partial parameters of the point in the feasible solution space, thus forming a combined input parameter.

If the function value obtained by inputting the combined input parameters into the trained predictive model meets the target result, that is, the point in the feasible solution space is a feasible solution. Consequently, the partial parameters of that point (i.e., the parameters not corresponding to the confirmed input parameters) can be considered as the unconfirmed input parameters, as described in step S15. For example, if the first 7 days of a 21-day cell culture process are confirmed (i.e. confirmed input parameters), the unconfirmed input parameters determined in step S15 would be the input parameters for days 8 to 21.

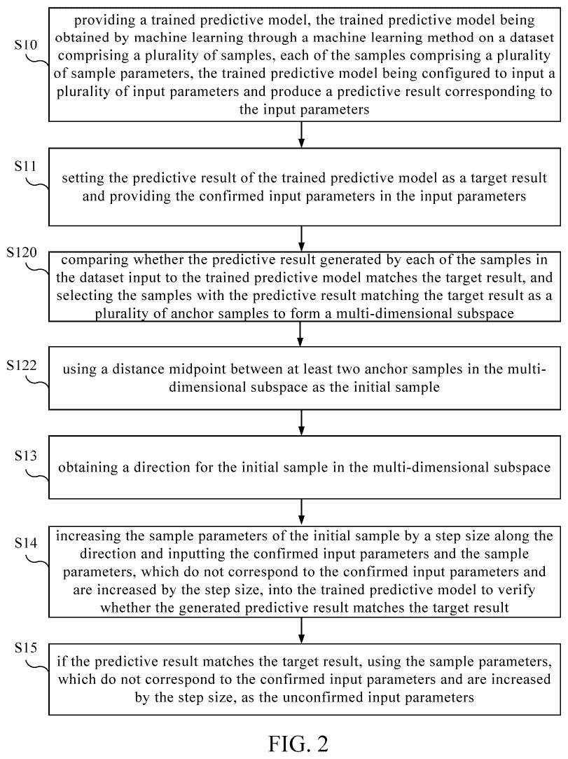

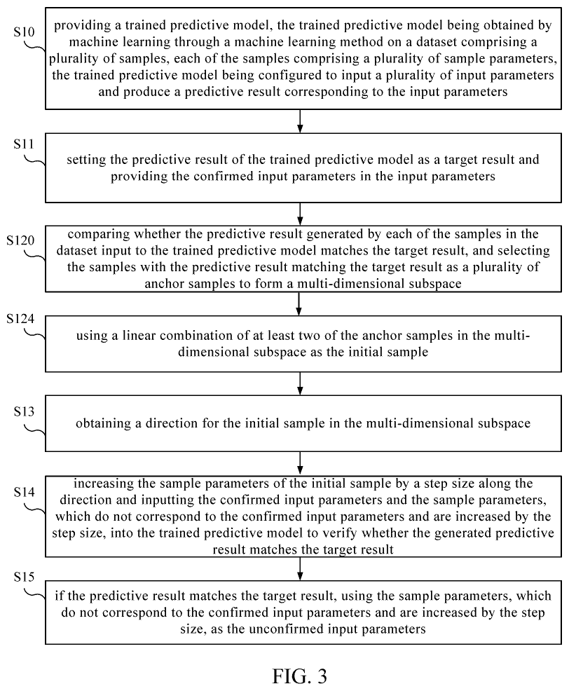

In the aforementioned embodiment, step S12 involves determining an initial sample in the multi-dimensional subspace. The method of the present invention includes various methods for determining the initial sample. Please refer to FIG. 2 and FIG. 3. FIG. 2 is a further flowchart diagram of the method for calculating feasible process parameters according to several embodiments of the present invention. FIG. 3 is another further flowchart diagram of the method for calculating feasible process parameters according to several embodiments of the present invention. As shown in FIG. 2, this embodiment differs from the previous embodiment in the step S12 further includes step S120 and sub-step S122. Wherein, step S120 corresponds to the step in the aforementioned S12 of finding a plurality of anchor samples from the dataset to form a multi-dimensional subspace. Step S122: using a distance midpoint between at least two anchor samples in the multi-dimensional subspace as the initial sample. Furthermore, as shown in FIG. 3, this embodiment differs in that step S12 further includes step S120 and step S124. Step S124: using a linear combination of at least two of the anchor samples in the multi-dimensional subspace as the initial sample. The aforementioned embodiments are merely two methods for determining the initial point in the feasible solution space. In practice, the present invention can employ any methods to determine the initial point or initial sample. Additionally, the other steps in the method for calculating feasible process parameters of the present embodiment in FIG. 2 and FIG. 3 are substantially similar to those described in the previous embodiments and would not be described again herein.

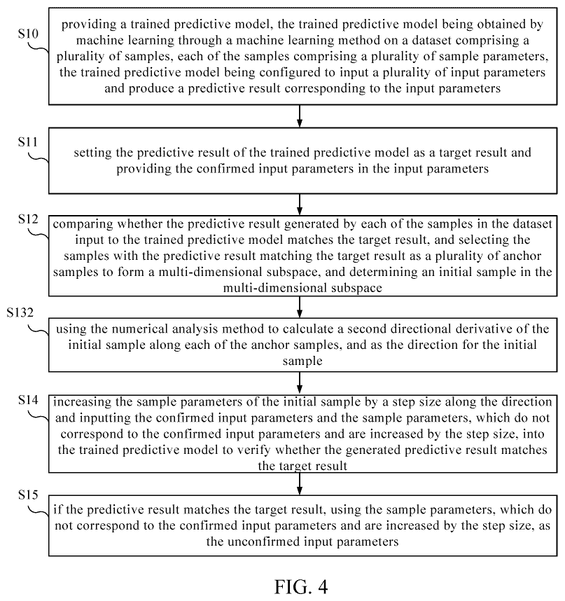

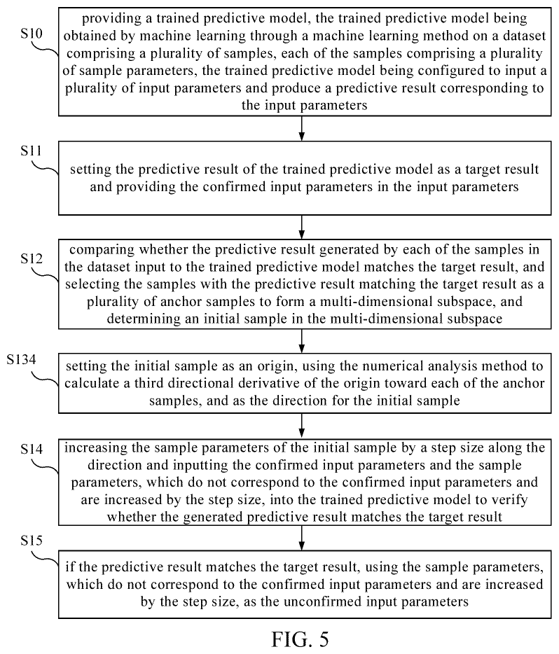

After the initial point is determined, it is still necessary to decide on the direction of advancement from the initial point. Please refer to FIG. 4 and FIG. 5. FIG. 4 is a flowchart diagram illustrating for determining a direction in the method for calculating feasible process parameters according to several embodiments of the present invention. FIG. 5 is a flowchart diagram illustrating for determining the direction in the method for calculating feasible process parameters according to several embodiments of the present invention. As shown in FIG. 4, this embodiment differs from the previous embodiment in that the method for calculating feasible process parameters further includes step S132. Step S132: using the numerical analysis method to calculate a second directional derivative of the initial sample along each of the anchor samples, and as the direction for the initial sample. As shown in FIG. 5, this embodiment differs from the previous embodiment in that the method for calculating feasible process parameters further includes step S134. Step S134: setting the initial sample as an origin, using the numerical analysis method to calculate a third directional derivative of the origin toward each of the anchor samples, and as the direction for the initial sample.

Alternatively, in the embodiment shown in FIG. 4, the direction of advancement can be chosen as the tangent direction from the initial sample toward the anchor sample, i.e., calculating the derivative in the second direction using the numerical analysis method. Note that a plurality of second directional derivatives from the initial sample will be applied to these anchor samples since there is a plurality of anchor samples. In practice, one of the second directional derivatives can be selected to advance one step size. The input parameters of the advanced point, combined with the confirmed input parameters, are then input into the trained predictive model to verify whether the output function value improves (i.e. whether the output function value is closer to the target result). If the function value improves, this second directional derivative is used as the direction of the initial sample. If the function value does not improve, the following second directional derivative is selected, and the exact steps are repeated until a second directional derivative that enhances the function value is found. Moreover, in the embodiment shown in FIG. 5, the initial sample can be set as the origin of the multi-dimensional subspace. Then, the numerical analysis method is used to calculate the third directional derivative of the origin toward each of the anchor samples. Similar to the present embodiment in FIG. 4, the third directional derivative that results in a better function value is selected as the direction of the initial sample. In this embodiment shown in FIG. 5, the new point reached in the feasible solution space can be used as the new initial point after advancing one step size from the initial sample. In other words, the current solution is set as the new origin, and step S134 of FIG. 5 is repeated to advance another one step size.

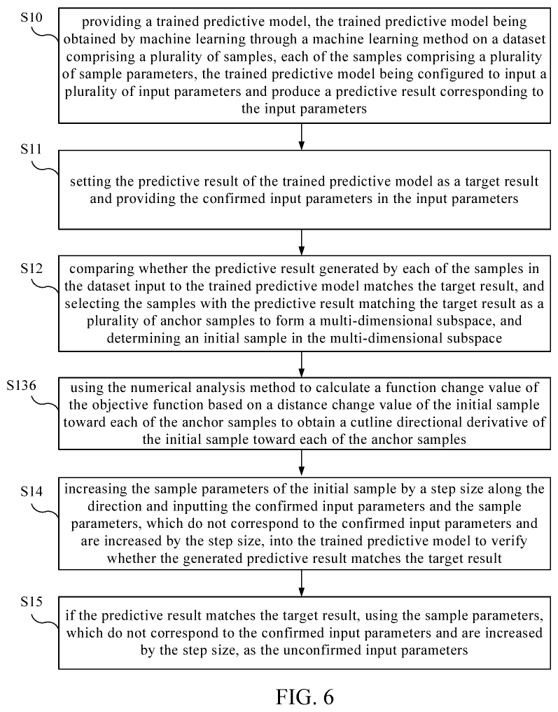

In the present embodiment as shown in FIG. 4, the tangent direction is used as the direction of advancement. However, the direction of the cutline from the initial sample to the anchor sample can also be used as the direction of advancement, as shown in the embodiment of FIG. 6. FIG. 6 is a flowchart diagram illustrating for determining the direction in the method for calculating feasible process parameters according to another embodiment of the present invention. As shown in FIG. 6, the present embodiment differs from the previous embodiments in that the trained predictive model in the present embodiment can be represented by a target function and the present embodiment further includes step S136. Step S136: using the numerical analysis method to calculate a function change value of the objective function based on a distance change value of the initial sample toward each of the anchor samples to obtain a cutline directional derivative of the initial sample toward each of the anchor samples.

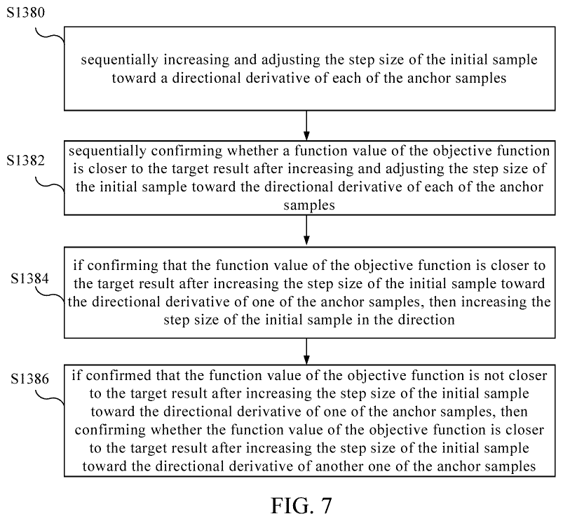

In the steps above-mentioned for determining direction, if the initial sample advances in the opposite direction of the feasible solution, the function value might be worse or less than expected. Therefore, the method of the present invention can sequentially find the direction that improves the function value. Please refer to FIG. 7. FIG. 7 is a flowchart diagram illustrating for determining the direction in the method for calculating feasible process parameters according to another embodiment of the present invention. As shown in FIG. 7, this embodiment differs from the previous embodiments in that this embodiment further includes the following steps. Step S1380: sequentially increasing and adjusting the step size of the initial sample toward a directional derivative of each of the anchor samples. Step S1382: sequentially confirming whether a function value of the objective function is closer to the target result after increasing and adjusting the step size of the initial sample toward the directional derivative of each of the anchor samples. Step S1384: if confirming that the function value of the objective function is closer to the target result after increasing the step size of the initial sample toward the directional derivative of one of the anchor samples, then increasing the step size of the initial sample in the direction. Step S1386: if confirmed that the function value of the objective function is not closer to the target result after increasing the step size of the initial sample toward the directional derivative of one of the anchor samples, then confirming whether the function value of the objective function is closer to the target result after increasing the step size of the initial sample toward the directional derivative of another one of the anchor samples. Therefore, in the present embodiment, the process starts by repeatedly adjusting the step size from the initial sample toward the direction of the first anchor sample and confirming whether the function value improves after each adjustment. If a suitable step size is found, the initial sample advances by this step size in the direction. If a suitable step size is not found after a certain number of adjustments, the process is repeated for the direction toward the following anchor sample. Wherein, the above-mentioned adjustment of the step size can first set an initial size for the step size, confirm that the initial size of the step size is used for the initial sample, and then input it into the trained predictive model to determine whether the output of the prediction result is close to the target result. If the prediction result is close to the target result, then it can be moved forward with the step size of the initial size. If the prediction result is not close to the target result, then it can be repeatedly adjusted the size of the step size until the prediction result output by the trained predictive model is close to the target result. In practice, if no suitable step size is found in any direction toward all anchor samples to improve the function value (e.g., after adjusting the step size 10 times), the method for calculating feasible process parameters stops. The above steps represent a cyclic exploration process. When the initial point advances to a new point in the feasible solution space, this new point can be set as the current solution, and the steps are repeated.

In the present embodiment, the dataset further comprises a process dataset, the process dataset comprises a plurality of process samples, and each of the sample parameters of the process samples comprises a source parameter and a culture parameter. When the method for calculating feasible process parameters of the present embodiment is applied to cell culture processes, the process dataset can be a cell dataset. In practice, the cell dataset can be obtained from any public platform or collected by the user. In addition, the types of the cell samples can include immune cells (such as dendritic cells (DC cells), cytokine-induced killer cells (CIK), tumor-infiltrating lymphocytes (TIL), natural killer cells (NK cells), and CAR-T cells), stem cells (such as peripheral blood stem cells, adipose stem cells, and bone marrow mesenchymal stem cells), chondrocytes, fibroblasts, etc. In practice, it is not limited to the aforementioned, and it can be decided according to the type of cell culture that the user needs to perform. Moreover, in the present embodiment, the source parameter of each of the process samples can further comprise attribute data of a source of each of the process samples. Each of the cell samples in the cell dataset can comprise information about the source associated with the cell and the attribute data of the source, and the attribute data can be physiological data or other relevant data about the source, such as gender, age, medical history, living environment, geographical area of residence. In practice, it is not limited to the aforementioned; the source parameter of the cell samples can further include other parameters that can influence the cell process and are related to the origin of the cells.

Furthermore, in the present embodiment, the culture parameter of each of the process samples further comprises operation, tool, material, method, and environment data for each of the process samples. The cell culture process comprises many steps, and each of the steps can include numerous culture parameters. The parameters include those related to people (operation), such as the gender and age of the cell source, the experience and consistency of the cell culture operator, and the personnel, location, environment, and transportation variances associated with the surgical procedure. The parameters include those related to machinery (tool), such as the type and grade of the cell operation platform and the stability and accuracy of temperature and humidity control in the cell culture incubators. The parameters include those related to material, such as the material of the cell culture dishes and the components and ratios of the cell culture medium. The parameters include those related to the method, such as the techniques of the cell culture operators and the methods of the cell culture process. The parameters include those related to the environment, such as the ambient temperature, humidity, carbon dioxide concentration, and concentration of organic molecules in the cell culture environment.

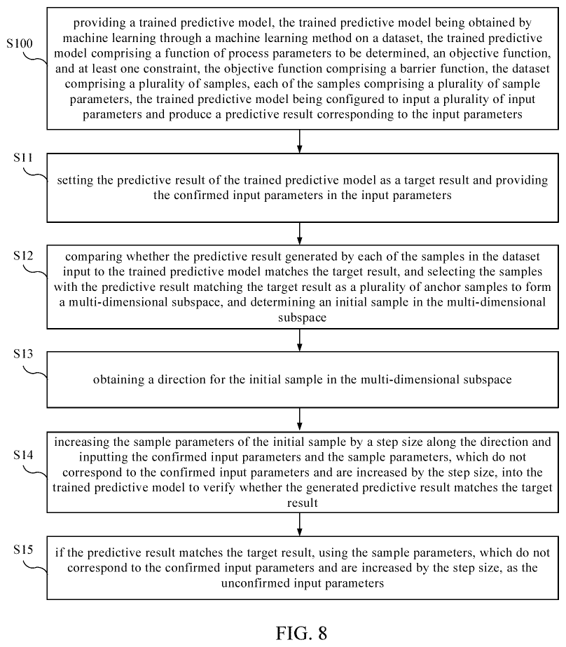

In a process, the process parameters are not arbitrarily set but can have various constraints based on actual conditions, the trained predictive model comprises a function of process parameters to be determined, an objective function, and at least one constraint, the objective function minimizes a difference between an output value of the function of the process parameters to be determined and the target result, a constrained optimization problem is modeled based on the function of the process parameters to be determined, the objective function, the at least one constraint and the predictive result, the method for calculating feasible process parameter solves the constrained optimization problem to obtain the unconfirmed input parameters. Please refer to FIG. 8. FIG. 8 is a flowchart diagram illustrating a method for calculating feasible process parameters according to another embodiment of the present invention. As shown in FIG. 8, this embodiment differs from the previous embodiments in that the method for calculating feasible process parameters further includes step S100. Step S100: providing a trained predictive model, the trained predictive model being obtained by machine learning through a machine learning method on a dataset, the trained predictive model comprising a function of process parameters to be determined, an objective function, and at least one constraint, the objective function comprising a barrier function, the dataset comprising a plurality of samples, each of the samples comprising a plurality of sample parameters, the trained predictive model being configured to input a plurality of input parameters and produce a predictive result corresponding to the input parameters.

In this embodiment, the barrier function is set to constrain the process parameters to meet an inequality condition. The barrier function includes a barrier region and a barrier function value. When the process parameters satisfy the inequality condition, they fall outside the barrier region, resulting in a barrier function value of 0, which means it has no impact on the predictive results of the trained predictive model. Conversely, when the process parameters do not satisfy the inequality condition, they fall within the barrier region, resulting in a significantly larger barrier function value, which substantially affects the predictive results of the trained predictive model. Note that the other steps in the method for calculating feasible process parameters of the present embodiment are substantially similar to those described in the previous embodiments and would not be described again herein.

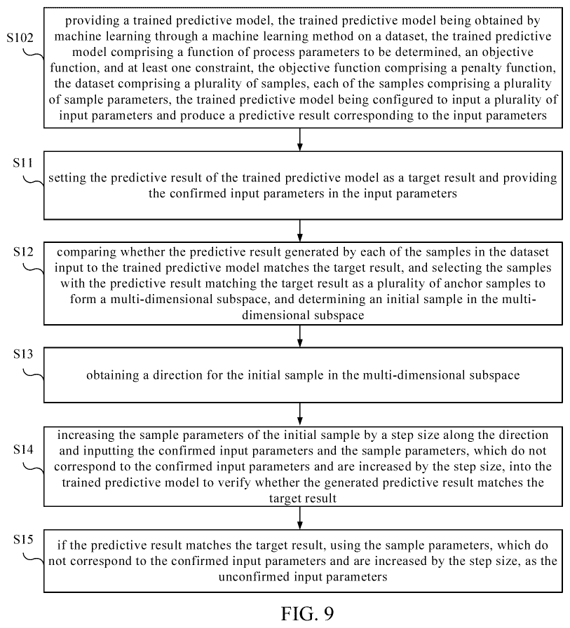

Additionally, please refer to FIG. 9. FIG. 9 is a flowchart diagram illustrating a method for calculating feasible process parameters according to another embodiment of the present invention. As shown in FIG. 9, this embodiment differs from the previous embodiments in that the method for calculating feasible process parameters of the present embodiment further includes step S102. Step S102: providing a trained predictive model, the trained predictive model being obtained by machine learning through a machine learning method on a dataset, the trained predictive model comprising a function of process parameters to be determined, an objective function, and at least one constraint, the objective function comprising a penalty function, the dataset comprising a plurality of samples, each of the samples comprising a plurality of sample parameters, the trained predictive model being configured to input a plurality of input parameters and produce a predictive result corresponding to the input parameters.

In this embodiment, the penalty function is set to constrain the process parameters to meet an equality condition. The penalty function includes a penalty region and a penalty function value. When the process parameters satisfy the equality condition, they fall within the penalty region, resulting in a penalty function value 0. When the process parameters do not fulfill the equality condition, they fall outside the penalty region, resulting in a significantly larger penalty function value, substantially affecting the predictive results of the trained predictive model. Therefore, when the sample parameters are input into the trained predictive model with a barrier function and a penalty function, it verifies whether the generated predictive results meet the target results and determines whether the input parameters comply with the actual constraints. If the input process parameters do not meet the conditions of the barrier function and/or penalty function, the predictive results will significantly deviate, indicating that the process parameters cannot be used due to the violation of conditions. Note that the other steps in the method for calculating feasible process parameters of the present embodiment are substantially similar to those described in the previous embodiments and would not be described again herein.

As an example of the aforementioned actual constraints, in a cell culture process, the combined antibiotic concentration of streptomycin and amphotericin B added to the cell culture medium on day 10 must be less than or equal to 200 μg/mL, and the combined serum concentration in the cell culture medium on days 8 and 10 must be less than or equal to 20%.

In practice, penalty function and barrier functions are commonly used in machine learning to keep the parameters of machine learning models within reasonable bounds, ensuring they adhere to natural environments and actual process conditions. For example, these functions can restrict cell culture temperatures and relative humidity to non-negative values and prevent culture medium component concentrations from harming the cells. By setting barrier functions and penalty functions to limit the range of parameters, the relationships between parameters are comprehensively considered, and the process parameter combination closest to the expected target result is found. Furthermore, in practice, barrier functions can be applied to unconfirmed input parameters, while penalty functions can be applied to confirmed input parameters. Both can be used interchangeably based on user requirements. In this embodiment, the objective function aims to minimize the difference between the function value and the target result while subjecting the individual or mutual process parameters to the constraints they must meet. Methods incorporating penalty functions and barrier functions can be used to solve the aforementioned constrained optimization problem. These methods convert the constrained optimization problem into an unconstrained optimization problem, making it more convenient to solve.

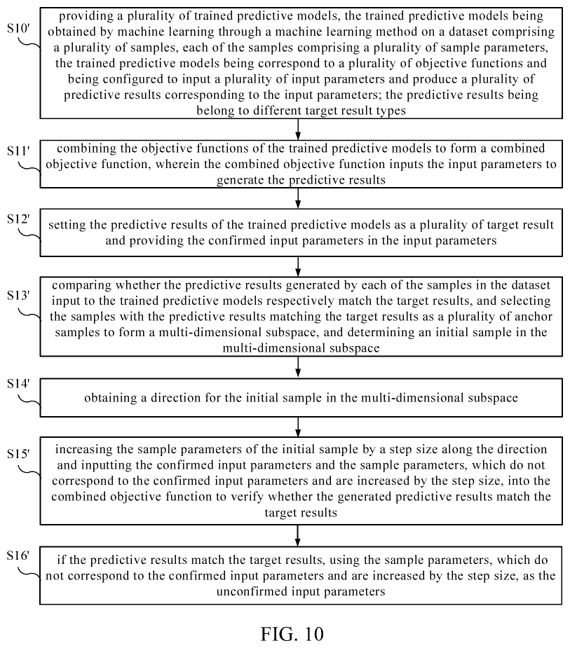

Additionally, a plurality of trained predictive models can be used to predict various results of the input parameters, such as cell viability, cell growth number, and culture time. Please refer to FIG. 10. FIG. 10 is a flowchart diagram illustrating a method for calculating feasible process parameters according to another embodiment of the present invention. The method for calculating feasible process parameters is for identifying and optimizing a plurality of process parameters in a process. The plurality of process parameters comprises a plurality of confirmed input parameters and a plurality of unconfirmed input parameters. The method for calculating feasible process parameters comprising the following steps of: step S10′: providing a plurality of trained predictive models, the trained predictive models being obtained by machine learning through a machine learning method on a dataset comprising a plurality of samples, each of the samples comprising a plurality of sample parameters, the trained predictive models being correspond to a plurality of objective functions and being configured to input a plurality of input parameters and produce a plurality of predictive results corresponding to the input parameters; the predictive results being belong to different target result types; step S11′: combining the objective functions of the trained predictive models to form a combined objective function, wherein the combined objective function inputs the input parameters to generate the predictive results; step S12′: setting the predictive results of the trained predictive models as a plurality of target result and providing the confirmed input parameters in the input parameters; step S13′: comparing whether the predictive results generated by each of the samples in the dataset input to the trained predictive models respectively match the target results, and selecting the samples with the predictive results matching the target results as a plurality of anchor samples to form a multi-dimensional subspace, and determining an initial sample in the multi-dimensional subspace; step S14′: obtaining a direction for the initial sample in the multi-dimensional subspace; step S15′: increasing the sample parameters of the initial sample by a step size along the direction and inputting the confirmed input parameters and the sample parameters, which do not correspond to the confirmed input parameters and are increased by the step size, into the combined objective function to verify whether the generated predictive results match the target results; and step S16′: if the predictive results match the target results, using the sample parameters, which do not correspond to the confirmed input parameters and are increased by the step size, as the unconfirmed input parameters.

Through the method for calculating feasible process parameters of the present embodiment, a set of input parameters can be inferred using each of the trained predictive models to simultaneously meet different expected results (e.g., ensuring the cell viability of the cultured cell product is above 90%, the cell count exceeds 1×10⁷, and the culture duration is 7 days). In the present embodiment, the objective functions of each of the trained predictive models can be combined in any manner, such as directly summing them to form a new function. This new function can then be processed using the various steps of the present invention to deduce in reverse and obtain a set of input parameters that simultaneously satisfy the above conditions. In another embodiment, these trained predictive models can incorporate barrier functions and/or penalty functions into the combined objective function. By adding barrier functions or penalty functions to the objective function, the more complicated constraints are transferred to the objective function to facilitate the solution.

In the aforementioned embodiment, the objective functions of each of the trained predictive models are combined by direct summation to form a new function, with the weight value of the objective function for each trained predictive model set to 1. However, in practice, the weight value of the objective functions for each trained predictive model can be adjusted based on the priority considerations and importance order of the expected results of different processes. Simultaneously, the barrier functions and penalty functions contained in the objective functions of each trained predictive model can also have their weight values set and adjusted according to the priority order of the expected process results. Additionally, constructing an optimization problem for a plurality of trained models can be achieved through the following two methods.

The first method: when each of the trained predictive models retains its own constrained optimization problem, its objective function can first be normalized (for example, converting the objective function of each trained predictive model into a form that minimizes the objective function). Each normalized objective function is then assigned a weight value to form a combined objective function. Subsequently, the constraints are considered and integrated for the combined objective function (i.e., taking the union of the limitations in each trained predictive model), transforming the constrained optimization problem into an unconstrained optimization problem. For example, equality constraints can be handled using penalty functions, while inequality constraints can be handled using barrier functions, forming a new function. Wherein, the constraints contained in the objective function of each trained predictive model have different weight values based on the priority order of the expected process results. By integrating each constraint and converting them into barrier function handling and penalty function handling, and considering the objective functions of each trained predictive model, the weight values for a barrier function and a penalty function are determined.

The second method: when the optimization problem of each trained predictive model is transformed into an unconstrained optimization problem (i.e., the constraints contained in each trained predictive model are separately handled by barrier functions and penalty functions and added to the objective function), there is no need to adjust the constraints. The objective function of each trained predictive model is normalized, and the corresponding weight values are adjusted to form a combined objective function. Then, the barrier functions and penalty functions contained in the objective function of each trained predictive model are added to create a new function. Wherein, the objective function of each trained predictive model can include its barrier functions and penalty functions. Each of the barrier functions and penalty functions can be assigned a corresponding weight value according to the priority of the objective function. Note that the other steps in the method for calculating feasible process parameters of the present embodiment are substantially similar to those described in the previous embodiments and would not be described again herein.

In summary, the method for calculating feasible process parameters of the present invention constructs an optimization model by treating a trained predictive model as a function of process parameters to be determined, wherein the objective function is to minimize the difference between the function value and the target result, subject to the conditions that the process parameters to be determined must satisfy, either individually or in relation to each other. Moreover, in order to solve the constrained optimization problem, the method with penalty function and barrier function can be used to convert the constrained optimization problem into an unconstrained optimization problem to make it more convenient to solve. For this optimization problem, the dataset of the trained predictive model can be used to find multiple samples that meet the target results as anchor points to form a multi-dimensional feasible solution space, and set or make initial solutions in this feasible solution space, and then use different numerical analysis methods to find the direction and step size to further find the optimal feasible solution, and this optimal feasible solution is the input parameter that can be used. In addition, the method for calculating feasible process parameters of the present invention can be applied not only in the field of cell process, but also in any other trained machine learning models to invert their process parameters and unconfirmed input parameters.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for calculating feasible process parameters for identifying and optimizing a plurality of process parameters in a process, the plurality of process parameters comprising a plurality of confirmed input parameters and a plurality of unconfirmed input parameters, the method for calculating feasible process parameters comprising the following steps of:
providing a trained predictive model, the trained predictive model being obtained by machine learning through a machine learning method on a dataset comprising a plurality of samples, each of the samples comprising a plurality of sample parameters, the trained predictive model being configured to input a plurality of input parameters and produce a predictive result corresponding to the input parameters;
setting the predictive result of the trained predictive model as a target result and providing the confirmed input parameters in the input parameters;
comparing whether the predictive result generated by each of the samples in the dataset input to the trained predictive model matches the target result, and selecting the samples with the predictive result matching the target result as a plurality of anchor samples to form a multi-dimensional subspace, and determining an initial sample in the multi-dimensional subspace;
obtaining a direction for the initial sample in the multi-dimensional subspace;
increasing the sample parameters of the initial sample by a step size along the direction and inputting the confirmed input parameters and the sample parameters, which do not correspond to the confirmed input parameters and are increased by the step size, into the trained predictive model to verify whether the generated predictive result matches the target result; and
if the predictive result matches the target result, using the sample parameters, which do not correspond to the confirmed input parameters and are increased by the step size, as the unconfirmed input parameters.

2. The method for calculating feasible process parameters of claim 1, wherein the step of determining the initial sample in the multi-dimensional subspace further comprises the following step:
using a distance midpoint between at least two anchor samples in the multi-dimensional subspace as the initial sample.

3. The method for calculating feasible process parameters of claim 1, wherein the step of determining the initial sample in the multi-dimensional subspace further comprises the following step:
using a linear combination of at least two of the anchor samples in the multi-dimensional subspace as the initial sample.

4. The method for calculating feasible process parameters of claim 1, wherein the step of obtaining the direction for the initial sample in the multi-dimensional subspace further comprises the following step:
using the numerical analysis method to calculate a second directional derivative of the initial sample along each of the anchor samples, and as the direction for the initial sample.

5. The method for calculating feasible process parameters according to claim 1, wherein the step of obtaining the direction for the initial sample in the multi-dimensional subspace further comprises the following step:
setting the initial sample as an origin, using the numerical analysis method to calculate a third directional derivative of the origin toward each of the anchor samples, and as the direction for the initial sample.

6. The method for calculating feasible process parameters of claim 1, wherein the trained predictive model is represented by a objective function and the step of obtaining the direction for the initial sample in the multi-dimensional subspace further comprises the following step:
using the numerical analysis method to calculate a function change value of the objective function based on a distance change value of the initial sample toward each of the anchor samples to obtain a cutline directional derivative of the initial sample toward each of the anchor samples.

7. The method for calculating feasible process parameters of claim 1, wherein the step of obtaining the direction for the initial sample in the multi-dimensional subspace further comprises the following steps:
sequentially increasing and adjusting the step size of the initial sample toward a directional derivative of each of the anchor samples;
sequentially confirming whether a function value of the objective function is closer to the target result after increasing and adjusting the step size of the initial sample toward the directional derivative of each of the anchor samples;
if confirming that the function value of the objective function is closer to the target result after increasing the step size of the initial sample toward the directional derivative of one of the anchor samples, then increasing the step size of the initial sample in the direction; and
if confirmed that the function value of the objective function is not closer to the target result after increasing the step size of the initial sample toward the directional derivative of one of the anchor samples, then confirming whether the function value of the objective function is closer to the target result after increasing the step size of the initial sample toward the directional derivative of another one of the anchor samples.

8. The method for calculating feasible process parameters of claim 1, wherein the step of increasing the sample parameters of the initial sample by the step size along the direction further comprises the following steps:
setting an initial size of the step size, inputting the sample parameters of the initial sample in that direction by increasing the step size with the initial size, into the trained predictive model to verify whether the prediction result output by the trained predictive model is close to the target result;
if the prediction result output by the trained predictive model is close to the target result, determining the step size to be the initial size; and
if the prediction result output by the trained predictive model is not close to the target result, continuously adjusting a size of the step size, inputting the sample parameters of the initial sample in that direction by increasing the step size with the size, into the trained predictive model until the prediction result is close to the target result, and determining the step size to be the size.

9. The method for calculating feasible process parameters of claim 1, wherein the trained predictive model comprises a function of process parameters to be determined, an objective function, and at least one constraint, the objective function minimizes a difference between an output value of the function of the process parameters to be determined and the target result, a constrained optimization problem is modeled based on the function of the process parameters to be determined, the objective function, the at least one constraint and the predictive result, the method for calculating feasible process parameter solves the constrained optimization problem to obtain the unconfirmed input parameters.

10. The method for calculating feasible process parameters of claim 9, further comprising the following step:
adding a barrier function to the objective function to constrain the process parameters to meet an inequality condition.

11. The method for calculating feasible process parameters, of claim 9, further comprises the following step:
adding a penalty function to the objective function to constrain the process parameters to meet an equality condition.

12. The method for calculating feasible process parameters of claim 1, wherein the dataset further comprises a process dataset, the process dataset comprises a plurality of process samples, and the sample parameters of each of the process samples comprise a source parameter and a culture parameter.

13. The method for calculating feasible process parameters of claim 12, wherein the source parameter of each of the process samples further comprises an attribute data of a source of each of the process samples, and the culture parameter of each of the process samples further comprises operation, tool, material, method and environment data for each of the process samples.

14. The method for calculating feasible process parameters of claim 1, wherein the trained predictive model is obtained through machine learning of the dataset with one of the following techniques: an Artificial Neural Network (ANN), a Convolutional Neural Network (CNN), and a Recurrent Neural Network (RNN).

15. The method for calculating feasible process parameters of claim 1, further comprising the following steps:
if the predictive result does not match the target result, re-comparing the confirmed input parameters and the sample parameters of the samples to select a second sample from the samples;
calculating a gradient of the second sample in the target function of the trained predictive model with the numerical analysis method;
increasing the sample parameters of the second sample by the step size along the opposite direction of the gradient and inputting all the sample parameters after increasing the step size into the trained predictive model to confirm whether the generated predictive result matches the target result; and
if the predictive result matches the target result, using the sample parameters, which do not correspond to the confirmed input parameters and are increased by the step size, as the unconfirmed input parameters.

16. A method for calculating feasible process parameters for identifying and optimizing a plurality of process parameters in a process, the plurality of process parameters comprising a plurality of confirmed input parameters and a plurality of unconfirmed input parameters, the method for calculating feasible process parameters comprising the following steps of:
providing a plurality of trained predictive models, the trained predictive models being obtained by machine learning through a machine learning method on a dataset comprising a plurality of samples, each of the samples comprising a plurality of sample parameters, the trained predictive models being correspond to a plurality of objective functions and being configured to input a plurality of input parameters and produce a plurality of predictive results corresponding to the input parameters; the predictive results being belong to different target result types;
combining the objective functions of the trained predictive models to form a combined objective function, wherein the combined objective function inputs the input parameters to generate the predictive results;
setting the predictive results of the trained predictive models as a plurality of target result and providing the confirmed input parameters in the input parameters;
comparing whether the predictive results generated by each of the samples in the dataset input to the trained predictive models respectively match the target results, and selecting the samples with the predictive results matching the target results as a plurality of anchor samples to form a multi-dimensional subspace, and determining an initial sample in the multi-dimensional subspace;
obtaining a direction for the initial sample in the multi-dimensional subspace;
increasing the sample parameters of the initial sample by a step size along the direction and inputting the confirmed input parameters and the sample parameters, which do not correspond to the confirmed input parameters and are increased by the step size, into the combined objective function to verify whether the generated predictive results match the target results; and
if the predictive results match the target results, using the sample parameters, which do not correspond to the confirmed input parameters and are increased by the step size, as the unconfirmed input parameters.

17. The method for calculating feasible process parameters of claim 16, further comprising the following step:
adding a barrier function to the combined objective function to constrain the process parameters to meet an inequality condition.

18. The method for calculating feasible process parameters of claim 16, further comprising the following step:
adding a penalty function to the combined objective function to constrain the process parameters to meet an inequality condition.
